(19) United States
(12) Patent Application Publication
(10) Pub. No.: US 2025/0383653 A1
(43) Pub. Date: Dec. 18, 2025

(54) HYPERPARAMETER TUNING FOR GENERATIVE ARTIFICIAL INTELLIGENCE PROMPT ENGINEERING

(71) Applicant: Rockwell Automation Technologies, Inc., Mayfield Heights, OH (US)

(72) Inventors: Meiling He, Shorewood, WI (US); Ankan Chowdhury, Pimpri-Chinchwad (IN); Francisco Maturana, Lyndhurst, OH (US); Aderiano M. da Silva, Oak Creek, WI (US); Brady M. Chyla, Waukesha, WI (US)

(21) Appl. No.: 18/745,607

(22) Filed: Jun. 17, 2024

(51) Int. Cl. G05B 19/418

(52) U.S. Cl. CPC G05B 19/41885

(57) ABSTRACT

Disclosed herein are methods and systems that provide hyperparameter tuning for generative artificial intelligence prompt engineering to users prompting a generative artificial intelligence (GAI) model to return an executable logic code output. Where a user inputs a portion, a prompt is received and an iteration of a hyperparameter tuning process is executed. The assistant receives the prompt from the user and generates a number of hyperparameter sets. Each of the hyperparameter sets and a copy of the prompt are used to generate a number of complete prompts, where each complete prompt corresponds to a hyperparameter set. The complete prompts are submitted to a generative artificial intelligence model, which returns a number of responses corresponding to each complete prompt. A user selects a response, and the hyperparameters associated with the choice are the basis of a next hyperparameter tuning process iteration.

### BACKGROUND

In many commercial and enterprise applications, generative artificial intelligence (GAI) models are tasked with creating content such as text, images, audio signals, and synthetic data for a broad range of needs. Often, the content requested from a GAI model is highly particular and must satisfy a number of the user's requirements to be sufficient for the user's needs. In many such cases, AI models may struggle to produce sufficient outputs that function as intended. One strategy for achieving highly particular outputs from a GAI model is the technique of prompt engineering.

Prompt Engineering involves systematic design and optimization of prompts to guide GAI models towards specific outputs. Prompt engineering has gained popularity in recent years due to its effectiveness in fine-tuning pre-trained models like GPT-3®, GPT-4®, and GEMINI℠ 1.5 to generate more accurate and relevant responses. To perform prompt engineering, users create prompts to guide models to desired outputs by providing the model with instructions, context, input formats, output formats, and the like using a GAI application. GAI applications provide interfaces for users to generate prompts that the GAI application submits to the GAI model. GAI applications typically add system prompts, which are safeguards concatenated with the user-submitted prompt to protect against undesirable responses (e.g., rules to avoid responses that teach illegal or immoral behaviors). In addition to system prompts, GAI applications often add arguments that include hyperparameters and values for the hyperparameters that the GAI model uses to fine-tune responses. Many GAI applications do not expose available hyperparameters to the user or allow the user to select values for the hyperparameters. However, hyperparameters are a valuable tool for eliciting optimal responses from a GAI model. Unlike model parameters, which are learned by a GAI model during training and fine tuning and are not adjustable after training, hyperparameters are adjustable with each prompt submission. Hyperparameters can be utilized in a model-centric approach, where the focus is on model characteristics, or in a data-centric approach, where the focus is on output characteristics.

The choice of hyperparameter values can have a significant impact on the GAI model's performance. Unfortunately, it is impossible to know in advance which hyperparameter values are optimal and will result in the highest quality responses for a given task. Further, since hyperparameters are often not exposed to the user, the user is unable to set or fine-tune the hyperparameters. However, even with exposure, hyperparameter tuning can be resource inefficient, time-consuming, and can easily overwhelm a user, leading to poor responses, hallucinations, and dissatisfaction leading to potential abandonment of GAI models and applications. Accordingly, improvements are needed for efficiently and effectively tuning hyperparameters.

### SUMMARY

To address the issues described above, a copilot-type assistant within a software development environment that includes automatic hyperparameter tuning and next-word suggestion is disclosed. The assistant provides logic code development assistance to users prompting a generative artificial intelligence (GAI) model to return an executable logic code output. Once the user submits the user portion of the prompt, the assistant generates multiple hyperparameter sets and repeatedly submits the prompt with a different hyperparameter set until each generated hyperparameter set is used. The assistant provides the responses to the user, and the user can select one as being closest to the desired output. Based on the selection, the assistant knows which hyperparameter set is closest to generating the desired response. The user can then resubmit the prompt, and the assistant will generate more hyperparameter sets, this time based on the selected hyperparameter set. This process can continue until the hyperparameters are fine-tuned to the user's liking. Additionally, a next word suggestion model may be implemented to assist the user with selecting words for the prompt to elicit the desired response from the GAI model given the chosen software development language for the executable code being requested.

More specifically a system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method executed by the software development assistant that includes receiving, via a user interface, at least a portion of a prompt designed for submission to a generative artificial intelligence model, where the prompt requests a response in a form of logic code executable by an industrial automation controller. The software development assistant may execute an iteration of a hyperparameter tuning process. The hyperparameter tuning process includes generating, by a hyperparameter tuning module, a plurality of hyperparameter sets, where the hyperparameter tuning module generates the plurality of hyperparameter sets using a hyperparameter tuning model trained to generate hyperparameter sets for iterations of the hyperparameter tuning process based at least in part on hyperparameter sets associated with response selections in prior iterations. The hyperparameter tuning process further includes generating, by a prompt generation module, a plurality of complete prompts, where each complete prompt may include one of the plurality of hyperparameter sets and the at least the portion of a prompt. The hyperparameter tuning process further includes submitting each complete prompt to the generative artificial intelligence model and receiving a plurality of responses from the generative artificial intelligence model, where each response of the plurality of responses corresponds to one of the plurality of complete prompts. The hyperparameter tuning process further includes providing, via the user interface, each response of the plurality of responses, and receiving, via the user interface, a response selection chosen from one of the plurality of responses. The method also includes executing a next iteration of the hyperparameter tuning process based on the response selection. Further iterations may be performed to complete the hyperparameter fine-tuning. Other embodiments of this aspect include corresponding computer systems, apparatus, and computer programs recorded on one or more computer storage devices, each configured to perform the actions of the methods.

Implementations may include one or more of the following features. Optionally, executing the next iteration may include repeating the hyperparameter tuning process based on a continued tuning request received via the user interface.

In some embodiments, the hyperparameter tuning model is further trained to generate the hyperparameter sets to create a uniform distribution across a default range for each hyperparameter in the hyperparameter sets for an initial iteration of the hyperparameter tuning process.

In some embodiments, entered words of the prompt are sent to a next-word suggestion model trained to generate a suggestion for a next word to be used in the prompt. The next word suggestion model is further trained to suggest the next word for prompts designed to elicit responses from the generative artificial intelligence model in a form of executable logic code in a coding language to be used in an industrial automation process based at least in part on the entered words. The software development assistant receives the suggestion for the next word from the next-word suggestion model and provides instructions to display, via the user interface, a selectable indication of the suggestion for the next word. In some embodiments, the software development assistant may incorporate, in response to a selection of the selectable indication via the user interface, the next word after the entered words in the at least the portion of a prompt. In some embodiments, the next-word suggestion model may include a first domain-specific machine-learning model of a plurality of domain-specific machine-learning models, where each domain-specific machine-learning model is based on a domain associated with a specific coding language of a plurality of coding languages. The software development assistant may select, based on the domain associated with the coding language, the first domain-specific machine-learning model from the plurality of domain-specific machine-learning models.

Optionally, the method may further include receiving a storing indication associated with the response selection via the user interface, and in response to the storing indication, saving, to a repository, a hyperparameter set and the complete prompt associated with the response selection.

Optionally, the method may include periodically fine tuning each of the plurality of domain-specific machine-learning models based on data stored in the repository.

Optionally, the software development assistant may provide instructions to display, via the user interface, each hyperparameter set associated with each response.

In some embodiments, the hyperparameter tuning model is further trained to generate the hyperparameter sets based on an indication of an initial hyperparameter set in an initial iteration of the hyperparameter tuning process. The indication of the initial hyperparameter set may include a selection of a stored hyperparameter set or a user-entered hyperparameter set as the initial hyperparameter set.

Optionally, the user interface may include a software development environment for developing logic code, and the method may include integrating a response selection from a prior iteration of the hyperparameter tuning process into logic code under development in the user interface. Implementations of the described techniques may include hardware, a method or process, or computer software on a computer-accessible medium.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operating environment in accordance with some embodiments of the present technology.

FIG. 2 illustrates an operating environment in greater detail in accordance with some embodiments of the present technology.

FIG. 3 illustrates a hyperparameter tuning process in accordance with some embodiments of the present technology.

FIG. 4 illustrates an operational sequence in accordance with some embodiments of the present technology.

FIG. 5 illustrates multiple example prompts in accordance with some embodiments of the present technology.

FIG. 6 illustrates a user interface in accordance with some embodiments of the present technology.

FIG. 7 illustrates a computing system in accordance with some embodiments of the present technology.

### DETAILED DESCRIPTION

As discussed above, hyperparameter tuning is a difficult process and sometimes not even an option for users. To address those issues, a software development assistant with automatic hyperparameter tuning functionality is disclosed. The assistant provides logic code development assistance via hyperparameter tuning and next-word suggestion to users prompting a generative artificial intelligence (GAI) model to return an executable logic code output. The desired logic code output can be executed on an industrial automation controller, thereby governing the behavior of the industrial device controlled by the controller. Where the user inputs at least a portion of a prompt instructing a GAI model to return executable logic code, the assistant receives the at least a portion of a prompt and executes an iteration of a hyperparameter tuning process.

To carry out the hyperparameter tuning process, the assistant generates a number of hyperparameter sets based on prior iterations of the hyperparameter tuning process. If the iteration is the initial execution of the hyperparameter tuning process, the assistant generates hyperparameters values uniformly distributed across the acceptable value range for each hyperparameter. The assistant generates a number of complete prompts, where each complete prompt contains a hyperparameter set of the number of hyperparameter sets and a copy of the at least portion of a prompt. Each complete prompt of the number of complete prompts is submitted to the GAI model, and a number of responses are received in return, where each response is a response to each respective complete prompt. The assistant provides the number of responses via a user interface, and in return, receives an indication of a response selection. The response selection can be used to inform the generation of subsequent hyperparameter sets, beneficially minimizing the time and frustration associated with tuning hyperparameters adequately to achieve effective executable logic code outputs. The assistant uses the response selection as a guide for a next iteration, and can optionally perform one or more of returning, providing instructions to display values for, or storing the hyperparameters corresponding to the response selection.

In some embodiments, the assistant additionally analyzes prompt entries, and with a next-suggestion module, generates a suggestion for a next word to be used in the prompt. The next-word suggestions are made with particularity such that the resulting prompt is configured to result in the highest quality executable logic code output from the GAI model, beneficially guiding developers to effective prompts for achieving their respective goals with GAI. In some embodiments, the next-word suggestion module leverages a domain-specific next-word suggestion model chosen from a repository hosting a number of domain-specific next-word suggestion models. The domains corresponding to each domain-specific next-word suggestion model include domains for particular coding languages, for particular tasks associated with various prompt entries, for particular standards associated with the performance of particular tasks, and the like. In some further embodiments, one or more of the domain-specific next-word suggestion models stored in the domain-specific next-word suggestion model repository are fine-tuned using prompt data saved to a repository.

Various embodiments of the present technology provide for a wide range of technical effects, advantages, and/or improvements to computing systems and components. For example, the automatic hyperparameter tuning disclosed expedites the hyperparameter tuning process, reducing processing cycles, bandwidth needed for submission of prompts with varying hyperparameters, and memory capacity needed for saved submissions, responses, and corresponding hyperparameters. Further, the next word suggestion features improve the resulting code, limiting errors in the industrial process that may lead to equipment failure and safety issues.

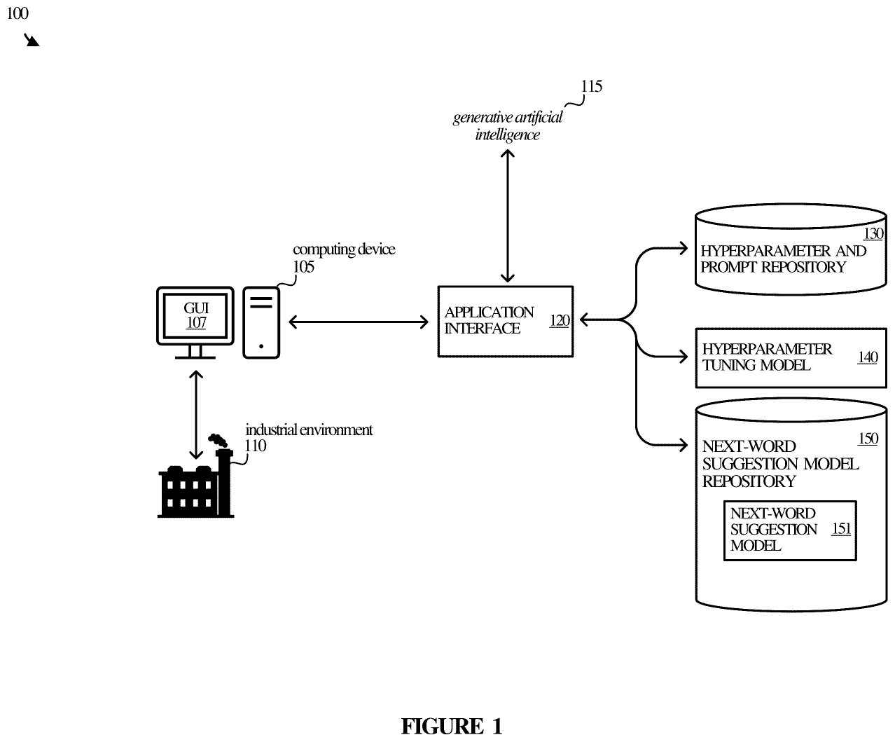

Now turning to the figures, FIG. 1 illustrates operating environment 100 in accordance with some embodiments of the present technology. Operating environment 100 includes computing device 105, industrial environment 110, generative artificial intelligence 115 (hereinafter GAI 115), application interface 120, hyperparameter and prompt repository 130, hyperparameter tuning model 140, and next-word suggestion model repository 150. Computing device 105 further includes graphical user interface 107 (hereinafter GUI 107). Next-word suggestion model repository 150 further includes next-word suggestion model 151.

Computing device 105 is generally representative of a computing device for interfacing with the elements of operating environment 100. Computing device 105 could be a local computing device or a distributed computing device and is communicatively coupled with industrial environment 110 and application interface 120. The communication between computing device 105 and industrial environment 110 and application interface 120, respectively, may be facilitated by a local network or distributed network. Computing device 105 may be a personal computing device, a laptop, a tablet, or any computing device sufficient to communicate industrial environment 110 and application interface 120 and to render a user interface associated with application interface 120. Computing device 105 is configured to provide application interface 120 with at least a portion of a prompt designed for submission to a GAI 115. Computing device 105 is further configured to provide application interface 120 with requests for hyperparameter tuning. Computing device 105 is further configured to receive from application interface 120, a plurality of response from GAI 115 associated with different versions of the at least portion of a prompt submitted previously. From the plurality of responses, a user determines a response selection, in response to which computing device 105 provides an indication of the response selection to application interface 120.

GUI 107 is generally representative of hardware, software, or firmware providing a graphical user interface that facilitates communication with other elements of operating environment 100. Communication with industrial environment 110 and application interface 120 is facilitated by GUI 107 but may be carried out by other means of input.

Industrial environment 110 is generally representative of an industrial environment in which industrial automation devices operate. Industrial environment 110 could be a manufacturing facility in which automated manufacturing devices execute tasks, for example. Where GUI 107 of computing device 105 is provided with executable logic code from GAI 115 via application interface 120, computing device 105 may send the executable logic code to industrial environment 110. Where executed, the executable logic code governs the behavior of an industrial device in industrial environment 110.

GAI 115 is generally representative of generative artificial intelligence sufficient to provide outputs in the form of executable logic code. GAI 115 may be local to application interface 120 or may be stored and queried remotely. GAI 115 may be representative of a generative artificial intelligence model, or else a higher level of interface or application used to communicate with the generative artificial intelligence model, such as a generative artificial intelligence application.

Application interface 120 is generally representative of hardware, software, or firmware for providing and coordinating logic code development assistant, and particularly, hyperparameter tuning and next-word suggestions. Application interface 120 is configured to receive from computing device 105 via GUI 107, at least a portion of a prompt and a request for hyperparameter tuning associated with the at least portion of a prompt. In response to receiving at least a portion of a prompt and a request for hyperparameter tuning, application interface 120 coordinates an iteration of a hyperparameter tuning process. To coordinate the iteration of a hyperparameter tuning process, application interface 120 is configured to generate a plurality of hyperparameter, to generate a plurality of complete prompts, and to submit the plurality of complete prompts to GAI 115. Application interface 120 is further configured to receive, from GAI 115, a plurality of responses corresponding to each of the complete prompt having been submitted to GAI 115. Application interface 120 is further configured to provide instructions for displaying the plurality of responses via GUI 107 of computing device 105, and to receive in response an indication of a response selection. In some cases, providing instructions for displaying the plurality of responses includes instructing a graphical processor to display the plurality of responses. In some other cases, providing instructions for displaying the plurality of responses includes instructing an additional computing device to display the plurality of responses. Application interface 120 then initiates a next iteration of the hyperparameter tuning process, where the selection of hyperparameters in the next iteration is based on the hyperparameters associated with the response selection of the prior iteration.

Hyperparameters as used throughout are model-centric and data-centric parameters for which values are provided as arguments in a prompt submitted to GAI 115. GAI 115 uses the submitted hyperparameters (i.e., the values submitted as arguments) to fine-tune the response to the request in the prompt. An example of such a hyperparameter is the temperature hyperparameter. The temperature hyperparameter controls the randomness of a GAI model's output, where lower temperature values correspond to more constrained and predictable responses, while higher temperature values correspond to more diverse and creative responses. The following example snippet of code illustrates one way a GAI application may submit the prompt with hyperparameters to select a value for the temperature hyperparameter of a GAI model accessed through an API called “GAIModel”:

$$response \text{} = \text{} GAIModel ( \text{} prompt \text{} = \text{} “ Write me a comical song about visiting the zoo ” , prompt\_args = \text{} \{ “ \text{} temperature ” \text{} : 0.9 \} )$$

The example snippet of code dictates that the response (the output of the model) should be generated with respect to the prompt directing the model to author a song, and the response should have a temperature hyperparameter value of 0.9. Assuming, for this example, that the range of acceptable temperature hyperparameter values ranges from 0.1 to 1.0, a temperature hyperparameter of 0.9 will result in diverse and creative responses. Additional examples of hyperparameters include Top-k Tokens, the embeddings dimension hyperparameter, and the learning rate hyperparameter. The Top-k Tokens hyperparameter restricts the selection of tokens to the k most likely options based on their probabilities. A smaller value for k generally prevents the consideration of tokens with very low probabilities, which in turn increases the focus and coherence of the output. The embeddings dimension hyperparameter dictates the number of dimensions used to represent word embeddings. An embedding is a relatively low-dimensional space into which you can translate high-dimensional vectors. The learning rate hyperparameter defines the rate at which model weights change between iterations. A large learning rate may cause large swings in the weights, while a low learning results in the model taking more iterations to converge. Hyperparameter and prompt repository 130 is generally representative of storage media sufficient to store hyperparameter sets and associated prompts. Hyperparameter and prompt repository 130 is configured to receive prompts and hyperparameters associated with a storage indication, and to provide relevant prompts and hyperparameters in response to requests to for training data to tune intelligence models.

Hyperparameter tuning model 140 is generally representative of an artificial intelligence model configured to generate, based on hyperparameters associated with response selections from prior hyperparameter tuning iterations, hyperparameter sets. Where an iteration of hyperparameter tuning is an initial iteration, hyperparameter tuning model 140 is further configured to select hyperparameter values uniformly distributed across the range of acceptable values for the given hyperparameter.

Next-word suggestion model repository 150 is generally representative of storage media sufficient to store a number of next-word suggestion models, such as next-word suggestion model 151. Next-word suggestion model 151 is generally representative of an artificial intelligence model configured to provide, in response to receiving entered words of the at least portion of a prompt from application interface 120, a suggestion for a next word to be included in the at least the portion of a prompt. Next-word suggestion model 151 is configured such that the suggested next word is chosen to increase the likelihood that a prompt resulting in high quality and highly particular output, such as a response in the form of executable logic code, is received from GAI 115.

In operation of an example, a user enters at least portion of a prompt and a request for hyperparameter tuning via GUI 107 of computing device 105. The portion of the prompt is intended to cause GAI 115 to return executable logic code for governing an industrial automation device of industrial environment 110. Application interface 120 receives the at least portion of a prompt from computing device 105, and leverages hyperparameter tuning model 140 to generate a number of hyperparameter sets. The volume of hyperparameter sets that application interface 120 requests here, and thus the number of prompts and outputs processed during the hyperparameter tuning process, may be predetermined by a user, and may be communicated to application interface 120 via GUI 107 of computing device 105. In the ongoing example, a value of three is selected for the volume of hyperparameter sets. For the sake of this example, each hyperparameter set contains only one hyperparameter, the temperature hyperparameter. Having no prior iterations to base the hyperparameter sets on, the below three snippets of Python code illustrate inputting value indications for the temperature hyperparameter that are uniformly distributed across the acceptable range of values for the hyperparameter. Assuming the acceptable range of temperature hyperparameter values ranges from 0.1 to 1.0, the following argument inputs represent a uniform distribution:

$$response \text{} = \text{} ChatGPT ( \text{} prompt \text{} = \text{} “ Write executable logic code to govern device A ” , prompt\_args = \text{} \{ “ \text{} temperature ” \text{} : 0.1 \} )$$

$$response \text{} = \text{} ChatGPT ( \text{} prompt \text{} = \text{} “ Write executable logic code to govern device A ” , prompt\_args = \text{} \{ “ \text{} temperature ” \text{} : 0.6 \} )$$

$$response \text{} = \text{} ChatGPT ( \text{} prompt \text{} = \text{} “ Write executable logic code to govern device A ” , prompt\_args = \text{} \{ “ \text{} temperature ” \text{} : 1. \} )$$

Note that where a hyperparameter may only be given a value with a certain number of digits, certain scenarios may require rounding the hyperparameter values, which may slightly affect the uniformity of the distribution.

Each of the three hyperparameter sets, along with the at least portion of a prompt, are included in three complete prompts, respectively. The complete prompts are submitted to GAI 115, which returns three versions of executable logic code corresponding to each of the three prompts. Each of the three responses is provided by application interface 120 via GUI 107. An indication of a response selection is received by application interface, and the associated hyperparameters are then stored in hyperparameter and prompt repository 130. In the ongoing example, the response selection is the first of the three prompts. As such, the temperature hyperparameter value of three, along with the associated prompt, are sent to hyperparameter and prompt repository 130 for storage.

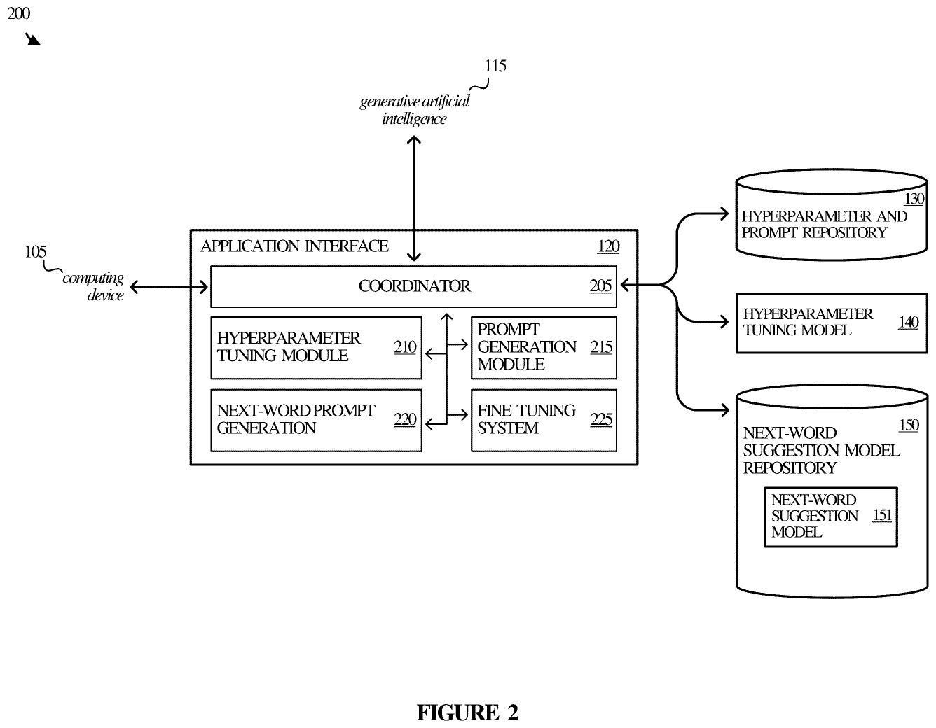

FIG. 2 illustrates an operating environment in greater detail, represented by environment 200, in accordance with some embodiments of the present technology. Environment 200 includes computing device 105, GAI 115, hyperparameter and prompt repository 130, hyperparameter tuning model 140, and next-word suggestion model repository 150, each of FIG. 1 and described in detail in the associated text of FIG. 1.

Environment 200 includes application interface 120 shown in greater detail and including coordinator 205, hyperparameter tuning module 210, prompt generation module 215, next-word prompt generation 220, and fine-tuning system 225.

Coordinator 205 is configured to receive from computing device 105 via GUI 107, at least a portion of a prompt and a request for hyperparameter tuning associated with the at least portion of a prompt. In response to receiving at least a portion of a prompt and a request for hyperparameter tuning, coordinator 205 coordinates an iteration of a hyperparameter tuning process. Coordinator 205 is configured to receive the at least portion of a prompt and a request for hyperparameter tuning from computing device 105. Coordinator 205 is further configured to send a request for a plurality of hyperparameter sets to hyperparameter tuning module 210 and to receive in return the plurality of hyperparameter sets. Coordinator 205 is further configured to send the plurality of hyperparameter sets to prompt generation module 215 along with a request for a plurality of prompts. Coordinator 205 receives each of the plurality of prompts, where each prompt includes a hyperparameter set of the plurality of hyperparameter sets and the at least portion of a prompt. Coordinator 205 sends the plurality of complete prompts to GAI 115, and receives in return a plurality of responses, each corresponding to one of the complete prompts. Coordinator 205 is further configured to provide the plurality of responses to computing device 105, and to receive in return a selection response. Coordinator 205 is further configured to initiate and coordinate the next execution of the hyperparameter tuning process.

Hyperparameter tuning module 210 is generally representative of hardware, software, or firmware that generates hyperparameter sets based on prior iterations of hyperparameter tuning, or else generates hyperparameter uniformly across the range of acceptable hyperparameter values the hyperparameter tuning process is an initial iteration. Hyperparameter tuning module 210 is communicatively coupled with coordinator 205. Hyperparameter tuning module 210 is configured to communicate with and leverage hyperparameter tuning model 140 via coordinator 205 to generate a number of hyperparameter sets for a hyperparameter tuning process. In some embodiments, hyperparameter tuning module 210 receives an indication to use, for hyperparameter tuning, one or more hyperparameters, one or more prompts, or a combination thereof existing in hyperparameter and prompt repository 130. In response to the indication, hyperparameter tuning module 210 requests, from hyperparameter and prompt repository 130, the stored one or more hyperparameters, one or more prompts, or a combination thereof associated with the indication. Hyperparameter and prompt repository 130 returns the requested elements stored therein, which coordinator 205 receives to be used for the hyperparameter tuning process.

Prompt generation module 215 is generally representative of hardware, software, or firmware that generates a number of prompts for submission to GAI 115. Each of the prompts includes a hyperparameter set and a copy of the at least portion of a prompt. Prompt generation module 215 is communicatively coupled with coordinator 205 and is configured to receive from coordinator 205 a request for a number of prompts. The volume of prompts coordinator 205 request from prompt generation module 215 is a product of the number of hyperparameter sets generated, which itself is a predetermined variable that a user may modify where desired. A practical default value for volume of hyperparameter sets, and thus prompts, is a value of three. However, any number of hyperparameter sets may be used to generate prompts.

Next-word prompt generation 220 is generally representative of hardware, software, or firmware that generates prompts configured to result in a suggestion for a next word to be used in the at least the portion of a prompt. Next-word prompt generation 220 is communicatively coupled with coordinator 205 and is configured to receive from coordinator 205 the at least portion of a prompt. Based on entered words of the at least portion of a prompt, next-word prompt generation 220 generates a prompt including the entered words and instructions to return a suggestion for a next word, where the next-word suggestion is selected such that complete prompts generated by prompt generation module that include the entered words and the next-word suggestion have an increased likelihood of returning executable logic code of an acceptable caliber. To generate a next-word suggestion, next-word prompt generation 220 is configured to communicate with and leverage next-word suggestion model 151 via coordinator 205.

Next-word suggestion model 151 is generally representative of an artificial intelligence model configured to suggest a next word for an at least portion of a prompt such that where the suggestion is implemented, the newly formed at least portion of a prompt has an increased likelihood of, when submitted to GAI 115 in a complete prompt, causing GAI 115 to return executable logic code of an acceptable caliber. In some embodiments, next-word suggestion model 151 is one of many domain-specific next-word suggestion models, where each domain-specific next-word suggestion model is configured to provide a next-word suggestion with regard to a particular domain of knowledge in addition to the executable logic code domain. For example, one domain-specific next-word suggestion model could be a Python coding language specific next-word suggestion model configured to offer a suggestion for a next word where the goal of the prompt is to cause GAI 115 to return executable logic code written in Python. In such examples, the domains corresponding to each domain-specific next-word suggestion model may be domains for particular coding languages, for particular tasks associated with various prompt entries, for particular standards associated with the performance of particular tasks, and the like.

Fine tuning system 225 is generally representative of hardware, software, or firmware that provides fine tuning for next-word suggestion model 151. Note that in addition to next-word suggestion model 151, fine tuning system 225 may provide periodic fine tuning for hyperparameter tuning model 140, any additional domain-specific next-word suggestion models, or any other artificial intelligence models capable of being fine-tuned. Fine tuning system 225 is communicatively coupled with coordinator 205 and is configured to receive from coordinator 205 a request for periodic fine tuning. In response to receiving the request, fine tuning system 225 is configured to periodically adjust model parameters for the model associated with the request based on a set of hyperparameters, a prompt, or a combination thereof, from an iteration of the hyperparameter tuning process. In some examples, periodic model parameter adjustment may be carried out a fixed schedule with fixed intervals between each adjustment, while in other examples periodic model parameter adjustment may be dynamically scheduled.

In operation of an example, coordinator 205 of application interface 120 receives an at least portion of a prompt from computing device 105. Coordinator 205 sends the at least portion of a prompt to hyperparameter tuning module 210, which leverages hyperparameter tuning model 140 to generate a number of hyperparameter sets. In the ongoing example, no value for the volume of hyperparameters sets to be generated was supplied, resulting in a default value of three. Hyperparameter tuning module 210 instructs hyperparameter tuning model 140 to generate the hyperparameter sets and receives three hyperparameter sets in response. The three hyperparameter sets are submitted to prompt generation module 215 via coordinator 205 along with the at least portion of a prompt and a request for prompt generation, where three complete prompts are generated. Each of the three prompts contains one of the three hyperparameter sets and the at least portion of a prompt. The three complete prompts are submitted to GAI 115 via coordinator 205, which returns three responses. The three responses are provided to computing device 105 via coordinator 205, along with a request for a response selection. Coordinator 205 receives back the response selection from computing device 105. Coordinator 205 initiates and coordinates a next iteration of the hyperparameter tuning process, where the hyperparameter set associated with the response selection is used during hyperparameter set generation. The hyperparameter set associated with the response selection may also be stored in hyperparameter and prompt repository 130. In some embodiments, the hyperparameter tuning process is continued in response to a continued tuning indication received at coordinator 205.

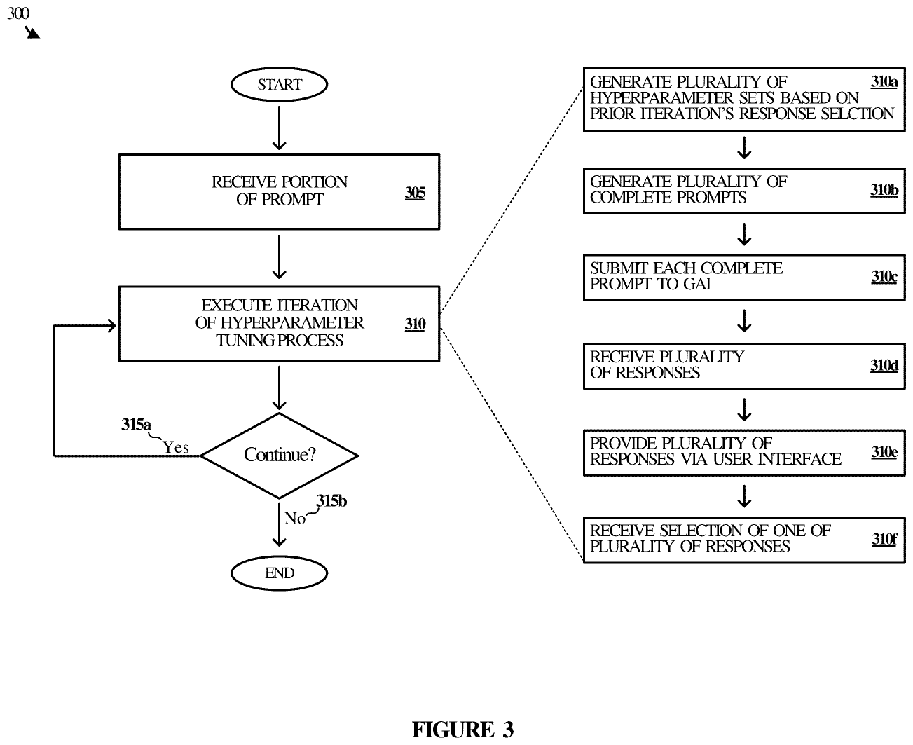

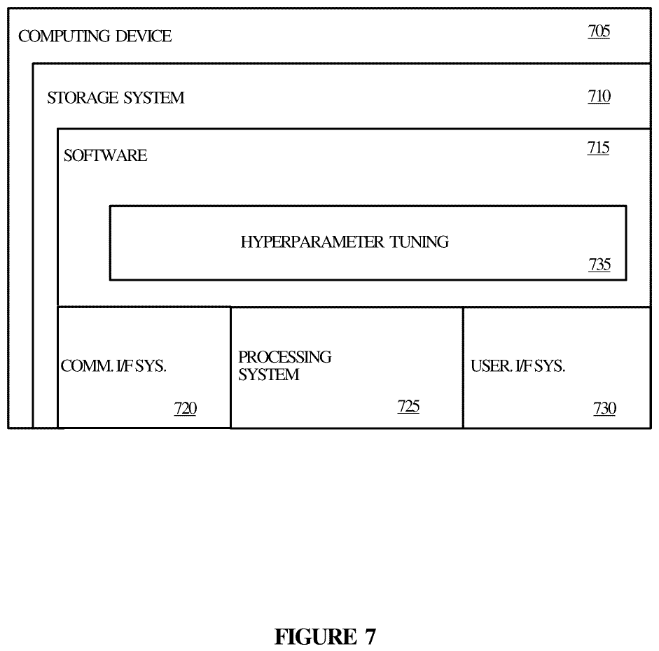

FIG. 3 illustrates hyperparameter tuning process 300 in accordance with some embodiments of the present technology. Hyperparameter tuning process 300 may be implemented in program instructions in the context of the software and/or firmware elements of operating environment 100. The program instructions, when executed by one or more processing devices of one or more computing systems (e.g., computing system 705 in FIG. 7), direct the one or more computing systems to perform the method 300.

At 305, a coordinator (e.g., coordinator 205) of an application interface (e.g., application interface 120) receives at least a portion of a prompt from a computing device (e.g., computing device 105). For example, the user of computing device 105 may submit at least a portion of a prompt into GUI 107. In response, at 310, the coordinator initiates and coordinates an iteration of a hyperparameter tuning process. The coordinator sends the submitted prompt to a hyperparameter tuning module (e.g., hyperparameter tuning module 210) of the application interface, which leverages a hyperparameter tuning model (e.g., hyperparameter tuning model 140) to generate a number of hyperparameter sets. In response, at 310a, the hyperparameter tuning model generates the hyperparameter sets. The coordinator, having received the hyperparameter sets, submits the hyperparameter sets, the submitted prompt portion, and a request for prompt generation, to a prompt generation module (e.g., prompt generation module 215). In response, at 310b, the prompt generation module returns a complete prompt for each hyperparameter set to the coordinator. For example, if there are three hyperparameter sets, the prompt generation module will generate three prompts, one with each of the hyperparameter sets. At 310c, the coordinator submits each of the complete prompts to a generative artificial intelligence model (e.g., generative artificial intelligence 115). At 310d, the generative artificial intelligence model returns responses that correspond to each complete prompt. At 310e, the responses are provided to the computing device by the coordinator. The coordinator may receive a response selection from the computing device at 310f. The response selection can be used in the next iteration of the hyperparameter tuning process. In some embodiments, the hyperparameter set associated with the response selection may be stored in hyperparameter and prompt repository 130. Where a continued tuning indication is received from the computing device via the coordinator, at 315a a next iteration of the hyperparameter tuning process is executed by returning back to 310a. Where no continued tuning indication is received from the computing device, at 315b the hyperparameter tuning process is ended.

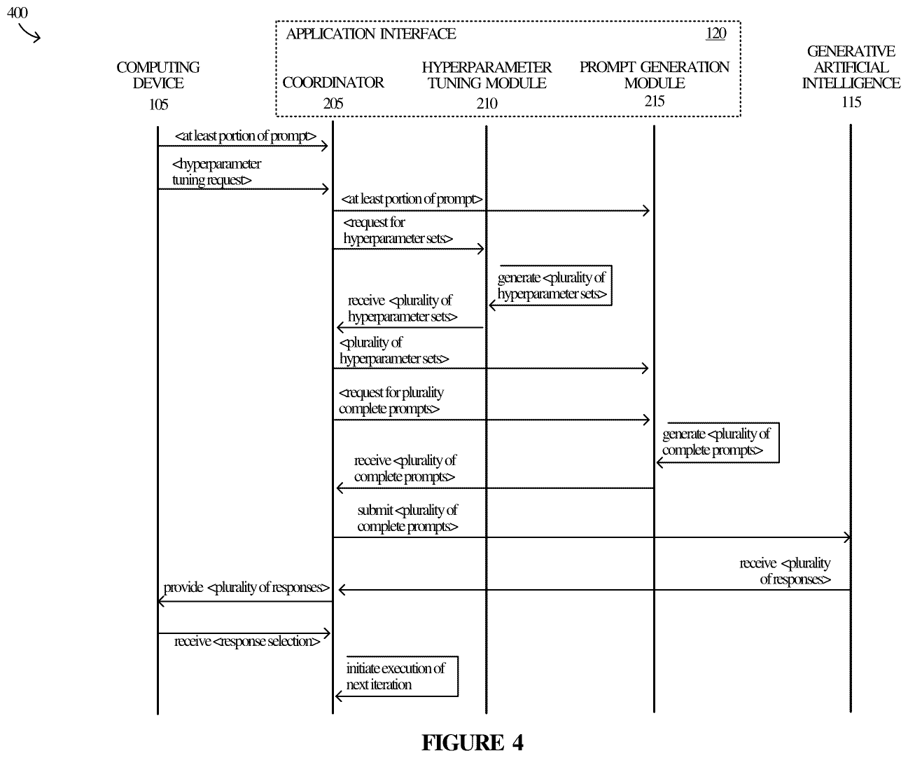

FIG. 4 illustrates an operational sequence 400 related to an application of hyperparameter tuning process 300 in the context of operating environment 100 in an implementation.

Operation sequence 400 begins with coordinator 205 of application interface 120 receiving an at least portion of a prompt and a request for hyperparameter tuning from computing device 105. Coordinator 205 sends the at least portion of a prompt to hyperparameter tuning module 210, which leverages hyperparameter tuning model 140 to generate a number of hyperparameter sets. Hyperparameter tuning module 210 instructs hyperparameter tuning model 140 to generate the hyperparameter sets and receives the number of hyperparameter sets in response. The number of hyperparameter sets are submitted to prompt generation module 215 via coordinator 205 along with the at least portion of a prompt and a request for prompt generation, where a number of complete prompts are generated. Each of the number of complete prompts contains one of the number of hyperparameter sets and the at least portion of a prompt. The number of complete prompts are submitted to GAI 115 via coordinator 205, which returns a number of responses. The number of responses are provided to computing device 105 via coordinator 205, along with a request for a response selection. Coordinator 205 receives back the response selection from computing device 105. Coordinator 205 initiates and coordinates a next iteration of the hyperparameter tuning process, where the hyperparameter set associated with the response selection is used during hyperparameter set generation. The hyperparameter set associated with the response selection may also be stored in hyperparameter and prompt repository 130. In some embodiments, the hyperparameter tuning process is continued in response to a continued tuning indication received at coordinator 205.

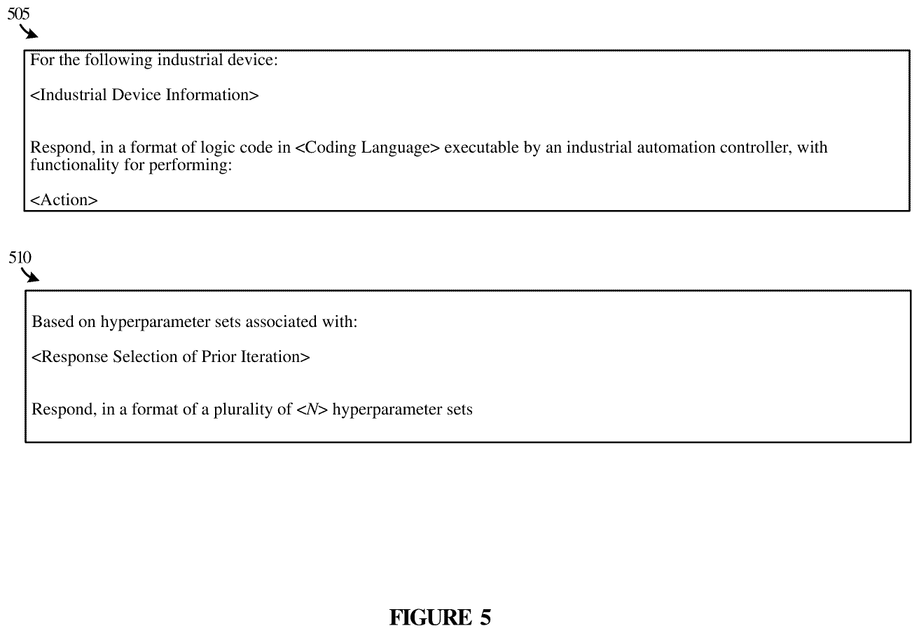

FIG. 5 illustrates multiple example prompts in accordance with some embodiments of the present technology. FIG. 5 includes example prompt 505, example prompt 510, and example prompt 515.

Example prompt 505 is generally representative of a prompt sent to a generative artificial intelligence model, such as GAI 115, intended to result in the model returning executable logic code in a particular coding language for a given action to be carried out by an industrial device. Example prompt 505 is generally illustrative of the at least portion of a prompt element discussed in greater detail in the associated text to the previous figures.

Example prompt 510 is generally representative of a prompt sent to a hyperparameter tuning model, such as hyperparameter tuning model 140, intended to result in the model returning a number of hyperparameter sets to be used in a hyperparameter tuning process. Example prompt 505 is generally illustrative of a prompt that a hyperparameter tuning module, such as hyperparameter tuning module 210, sends to a hyperparameter tuning model. Example prompt 510 is shown as having an argument for a “Response Selection of Prior Iteration” and for “N.” Based on the response selection of a prior iteration, the hyperparameter tuning model generates a number of hyperparameter sets equal to the value of N. Where no N value is entered, a default value may be applied. In some examples, a default N value of three is used. In some embodiments, where the hyperparameter tuning process is an initial iteration, and therefore no prior iteration exists to base hyperparameter generation upon, the hyperparameter tuning module constructs a prompt indicating that no prior iteration exists. In response, the hyperparameter tuning model generates a number of hyperparameter sets where the generated hyperparameter values are uniformly distributed across the range of acceptable values for each hyperparameter.

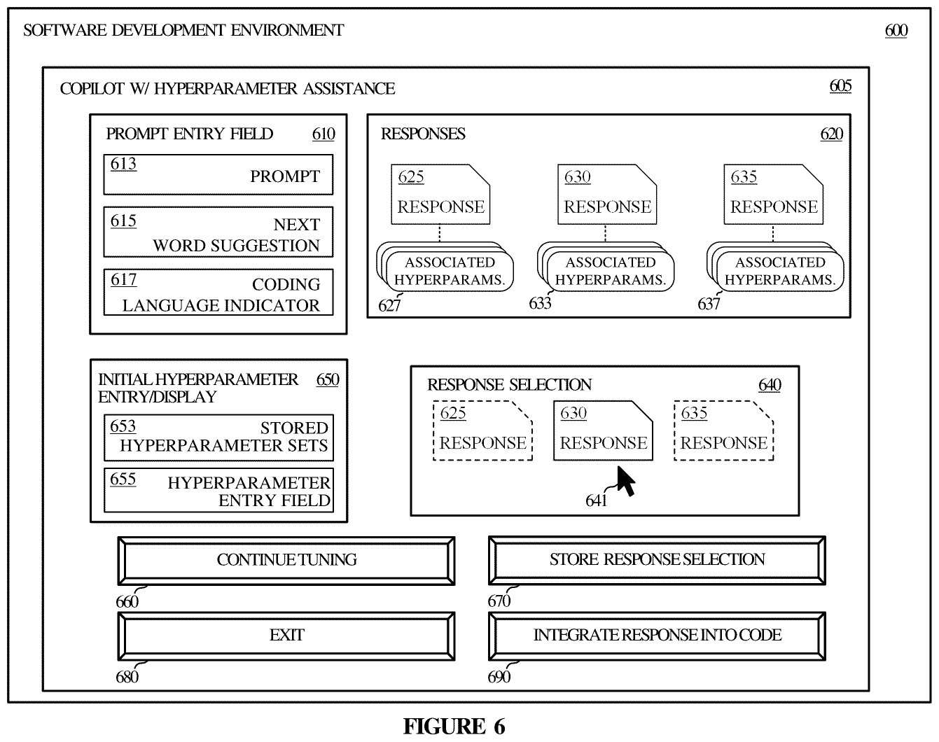

FIG. 6 illustrates software development environment 600 in accordance with some embodiments of the present technology. Software development environment 600 is generally representative of a development environment sufficient to develop prompts and configured to provide hyperparameter tuning. One example of software development environment 600 is STUDIO 5000® Automation Engineering and Design Environment by ROCKWELL AUTOMATION®. Software development environment 600 is rendered on a computing device, such as computing device 105. Software development environment 600 may be hardware, software, or firmware, local to the computing device or else distributed among other local or remote computing devices. Software development environment 600 includes copilot 605 with hyperparameter tuning. Copilot 605 is generally representative of an interface configured to provide logic code development assistance in the form of hyperparameter tuning and next-word suggestion for prompt development.

Copilot 605 includes prompt entry field 610, responses 620, initial hyperparameter entry/display 650, response selection 640, continue tuning button 660, store selected response 670, exit button 680, and integrate response selection into code button 690.

Prompt entry field 610 further includes prompt 613, next-word suggestion 615, and coding language indicator 617. Responses 620 further includes response 625, response 630, response 635, associated hyperparameters 627, associated hyperparameters 633, and associated hyperparameters 637. Initial hyperparameter entry/display 650 further includes stored hyperparameter sets 653 and hyperparameter entry field 655. Response selection 640 further includes response 625, response 630, response 635, and cursor 641.

Prompt entry field 610 is generally representative of hardware, software, or firmware configured to display a prompt, such as prompt 613, and to display a next-word suggestion, such as next-word suggestion 615. Prompt 613 is generally representative of a portion of a prompt received in addition to a request for hyperparameter tuning. Prompt 613 includes instructions that direct a generative artificial intelligence model to produce executable logic code sufficient to be used for governing an industrial device or an industrial automation device. Next-word suggestion 615 is configured to display the next-word suggestion generated by a next-word suggestion module leveraging a next-word suggestion model. In some embodiments, next-word suggestion 615 displays the suggestion, while in some other embodiments, next-word suggestion 615 is an interactable element. Where next-word suggestion 615 is an interactable element, selecting the element implements the next-word suggestion into prompt 613. At any point, selection of continue tuning button 660 submits prompt 613 for an iteration of hyperparameter tuning. Coding language indicator 617 is generally representative of a display and entry field for an indication of which coding language the executable logic code is desired in. For example, where a user wishes to receive executable logic code in Python, an indication of Python can be entered to coding language indicator 617.

Responses 620 is configured to display a number of responses from the generative artificial intelligence model. In some embodiments, each of the responses displayed in responses 620 has a corresponding set of hyperparameters. While responses 620 is shown to include includes response 625, response 630, response 635, associated hyperparameters 627, associated hyperparameters 633, and associated hyperparameters 637, responses 620 may include any number of responses, and may or may not include hyperparameter sets associated with each response.

Initial hyperparameter entry/display 650 is configured to receive, display, or a combination thereof, hyperparameter sets. Stored hyperparameter sets 653 is generally representative of hyperparameters and prompts saved to a repository, an example of which is given by hyperparameter and prompt repository 130 of FIG. 1. Hyperparameter entry field 655 is generally representative of a data entry field configured to receive manually entered hyperparameters and values.

Response selection 640 is generally representative of a display and entry field for an indication of a response selection. Response selection 640 is configured to display each of the responses provided by responses 620 as selectable elements, where selecting any of the elements constitutes an entry of a response selection. In some embodiments, the display of each of the responses not chosen as the response selection are modified such that they appear visually distinct from the response chosen as the response selection. Using cursor 641, a user of copilot 605 can enter the indication of the response selection.

Continue tuning button 660 is generally representative of an interactable element that, when interacted with, generates an indication of a request for continued tuning and sends the indication to a coordinator of an application interface, such as coordinator 205 of application interface 120.

Store selected response 670 is generally representative of an interactable element that, when interacted with, generates a storing indication that is sent to coordinator of an application interface, such as coordinator 205 of application interface 120. In response to the store response selection indication, the response selection is sent to a hyperparameter and prompt repository, such as hyperparameter and prompt repository 130.

Exit button 680 is generally representative of an interactable element that, when interacted with, exits copilot 605 and no request for further hyperparameter tuning is generated.

Integrate response selection into code button 690 is generally representative of an interactable element that, when interacted with, generates an integration indication that is sent to coordinator of an application interface, such as coordinator 205 of application interface 120. In response to the integration indication, the response selection is integrated into an existing, or a newly created, logic code that can be deployed to an industrial device or a controller governing an industrial device.

FIG. 7 illustrates example computing system 700 used in some embodiments of the present technology. Computing system 705 is representative of a computing device sufficient to execute software and communicate with peripherals. Computing system 705 is representative of any system or collection of systems with which the various operational architectures, processes, scenarios, and sequences disclosed herein for implementation of a logic code development assistant system may be employed. Computing system 705 may be implemented as a single apparatus, system, or device or may be implemented in a distributed manner as multiple apparatuses, systems, or devices. Computing system 705 includes, but is not limited to, processing system 725, storage system 710, software 715, communication interface system 720, and user interface system 730. Processing system 725 is operatively coupled with storage system 710, communication interface system 720, and user interface system 730. Computing system 705 may be representative of a cloud computing device, distributed computing device, or the like.

Processing system 725 loads and executes software 715 from storage system 710. Software 715 includes and implements hyperparameter tuning 735. When executed by processing system 725 to provide logic code development assistance, software 715 directs processing system 725 to operate as described herein for at least the various processes, operational scenarios, and sequences discussed in the foregoing implementations. Computing system 705 may optionally include additional devices, features, or functionality not discussed for purposes of brevity.

Processing system 725 may include a microprocessor and other circuitry that retrieves and executes software 715 from storage system 710. Processing system 725 may be implemented within a single processing device but may also be distributed across multiple processing devices or sub-systems that cooperate in executing program instructions. Examples of processing system 725 include general purpose central processing units, graphical processing units, application specific processors, and logic devices, as well as any other type of processing device, combinations, or variations thereof.

Storage system 710 may include any computer readable storage media readable by processing system 725 and capable of storing software 715. Storage system 710 may include volatile and nonvolatile, removable, and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations, storage system 710 may also include computer readable communication media over which at least some of software 715 may be communicated internally or externally. Storage system 710 may be implemented as a single storage device but may also be implemented across multiple storage devices or sub-systems co-located or distributed relative to each other. Storage system 710 may include additional elements, such as a controller capable of communicating with processing system 725 or other systems.

Software 715 (including hyperparameter tuning 735) may be implemented in program instructions and, when executed by processing system 725, can direct processing system 725 to operate as described with respect to the various operational scenarios, sequences, and processes illustrated herein. For example, software 715 may include program instructions for implementing a logic code development assistant.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 715 may include additional processes, programs, or components, such as operating system software, virtualization software, or other application software. Software 715 may also include firmware or some other form of machine-readable processing instructions executable by processing system 725.

In general, software 715 may, when loaded into processing system 725 and executed, transform a suitable apparatus, system, or device (of which computing system 705 is representative) overall from a general-purpose computing system into a special-purpose computing system customized to provide hyperparameter tuning as described herein. Indeed, encoding software 715 on storage system 710 may transform the physical structure of storage system 710. The specific transformation of the physical structure may depend on various factors in different implementations of this description. Examples of such factors may include, but are not limited to, the technology used to implement the storage media of storage system 710 and whether the computer-storage media are characterized as primary or secondary storage, as well as other factors.

For example, if the computer readable storage media are implemented as semiconductor-based memory, software 715 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 720 may include communication connections and devices that allow for communication with other computing systems (not shown) over communication networks (not shown). Examples of connections and devices that together allow for inter-system communication may include network interface cards, antennas, power amplifiers, radiofrequency circuitry, transceivers, and other communication circuitry. The connections and devices may communicate over communication media to exchange communications with other computing systems or networks of systems, such as metal, glass, air, or any other suitable communication media. The media, connections, and devices are well known and need not be discussed at length here.

Communication between computing system 705 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of networks, or variation thereof. The communication networks and protocols are well known and need not be discussed at length here.

While some examples provided herein are described in the context of an industrial environment, it should be understood that the hyperparameter tuning systems and methods described herein are not limited to such embodiments and may apply to a variety of other industrial environments and their associated systems. As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number, respectively. The word “or,” in reference to a list of two or more items, covers all of the following interpretations of the word: any of the items in the list, all of the items in the list, and any combination of the items in the list.

The phrases “in some embodiments,” “according to some embodiments,” “in the embodiments shown,” “in other embodiments,” and the like generally mean the particular feature, structure, or characteristic following the phrase is included in at least one implementation of the present technology and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A method, comprising:
receiving, via a user interface, at least a portion of a prompt designed for submission to a generative artificial intelligence model, wherein the prompt requests a response in a form of logic code executable by an industrial automation controller;
executing an iteration of a hyperparameter tuning process, comprising:
generating, by a hyperparameter tuning module, a plurality of hyperparameter sets, wherein the hyperparameter tuning module generates the plurality of hyperparameter sets using a hyperparameter tuning model trained to generate hyperparameter sets for iterations of the hyperparameter tuning process based at least in part on hyperparameter sets associated with response selections in prior iterations,
generating, by a prompt generation module, a plurality of complete prompts, wherein each complete prompt comprises one of the plurality of hyperparameter sets and the at least the portion of a prompt,
submitting each complete prompt to the generative artificial intelligence model,
receiving a plurality of responses from the generative artificial intelligence model, wherein each response of the plurality of responses corresponds to one of the plurality of complete prompts,
providing, via the user interface, each response of the plurality of responses, and
receiving, via the user interface, a response selection chosen from one of the plurality of responses; and
executing a next iteration of the hyperparameter tuning process based on the response selection.

2. The method of claim 1, wherein:
the executing a next iteration comprises repeating the executing of the hyperparameter tuning process based on a continued tuning request received via the user interface.

3. The method of claim 1, wherein:
the hyperparameter tuning model is further trained to generate the hyperparameter sets to create a uniform distribution across a default range for each hyperparameter in the hyperparameter sets for an initial iteration of the hyperparameter tuning process.

4. The method of claim 1, further comprising:
during entry of the at least the portion of a prompt:
sending entered words to a next-word suggestion model trained to generate a suggestion for a next word to be used in the at least the portion of a prompt subsequent to the entered words, wherein:
next-word suggestion model is further trained to suggest the next word for prompts designed to elicit responses from the generative artificial intelligence model in a form of executable logic code in a coding language to be used in an industrial automation process based at least in part on the entered words;
receiving, from the next-word suggestion model, the suggestion for the next word;
providing instructions to display, via the user interface, a selectable indication of the suggestion for the next word; and
incorporating, in response to a selection of the selectable indication via the user interface, the next word after the entered words in the at least the portion of a prompt.

5. The method of claim 4, wherein the next-word suggestion model comprises a first domain-specific machine-learning model of a plurality of domain-specific machine-learning models, wherein each domain-specific machine-learning model is based on a domain associated with a specific coding language of a plurality of coding languages, the method further comprising:
selecting, based on the domain associated with the coding language, the first domain-specific machine-learning model from the plurality of domain-specific machine-learning models.

6. The method of claim 5, further comprising:
receiving a storing indication associated with the response selection via the user interface, and
in response to the storing indication, saving, to a repository, a hyperparameter set and the complete prompt associated with the response selection.

7. The method of claim 6, further comprising:
periodically fine tuning each of the plurality of domain-specific machine-learning models based on data stored in the repository.

8. The method of claim 1, wherein:
providing each response comprises providing instructions to display, via the user interface, each hyperparameter set associated with each response.

9. The method of claim 1, wherein:
the hyperparameter tuning model is further trained to generate the hyperparameter sets based on an indication of an initial hyperparameter set in an initial iteration of the hyperparameter tuning process; and
the indication of the initial hyperparameter set comprises one of:
receiving, via the user interface, selection of a stored hyperparameter set as the initial hyperparameter set; and
receiving, via the user interface, a user-entered hyperparameter set as the initial hyperparameter set.

10. The method of claim 1, wherein the user interface comprises a software development environment for developing logic code, the method further comprising:
integrating a response selection from a prior iteration of the hyperparameter tuning process into logic code under development in the user interface.

11. A system, comprising:
a coordinator configured to:
receive, via a user interface, at least a portion of a prompt designed for submission to a generative artificial intelligence model, wherein the at least portion of a prompt requests a response in a form of logic code executable by an industrial automation controller;
receive, via the user interface, requests for hyperparameter tuning associated with the portion of a prompt; and
coordinate an iteration of a hyperparameter tuning process in response to the requests for hyperparameter tuning, wherein to coordinate the iteration, the coordinator is configured to:
receive, from a hyperparameter tuning module, a plurality of hyperparameter sets in response to requesting the plurality of hyperparameter sets;
receive, from a prompt generation module, a plurality of complete prompts in response to requesting the plurality of complete prompts;
receive a plurality of responses from the generative artificial intelligence model in response to submitting the plurality of complete prompts to the generative artificial intelligence model;
provide the plurality of responses via the user interface; and
receive, via the user interface, a response selection of one of the plurality of responses;
the prompt generation module configured to:
receive the request for the plurality of complete prompts and the plurality of hyperparameter sets from the coordinator;
generate a plurality of complete prompts, wherein each complete prompt comprises one of the plurality of hyperparameter sets and the at least the portion of a prompt; and
provide the plurality of complete prompts to the coordinator; and
the hyperparameter tuning module, further configured to:
receive, from the coordinator, a request for the plurality of hyperparameter sets; and
generate the plurality of hyperparameter sets, wherein the hyperparameter tuning module generates the plurality of hyperparameter sets using a hyperparameter tuning model trained to generate hyperparameter sets for iterations of the hyperparameter tuning process based at least in part on hyperparameter sets associated with response selections in prior iterations; and
provide the plurality of hyperparameter sets to the coordinator.

12. The system of claim 11, wherein:
the hyperparameter tuning model is further trained, in response to a request for a plurality of hyperparameter sets, to generate the hyperparameter sets to create a uniform distribution across a default range for each hyperparameter in the hyperparameter sets for an initial iteration of the hyperparameter tuning process.

13. The system of claim 11, further comprising:
a next-word suggestion model trained to:
in response to receiving an input comprising entered words, generate a suggestion for a next word to be used in the at least the portion of a prompt subsequent to the entered words, wherein:
the next-word suggestion model is further trained to suggest the next word for a prompt designed to elicit responses from the generative artificial intelligence model in a form of executable logic code in a coding language used in an industrial automation process based at least in part on the entered words;
a next-word suggestion module configured to:
during entry of the at least the portion of a prompt:
receive, from the coordinator, the entered words;
receive, from the next-word suggestion model, the suggestion for the next word in response to submitting the entered words to the next-word suggestion model;
generate a selectable indication of the suggestion for the next word and provide the selectable indication to the coordinator for display on the user interface; and
wherein the coordinator is further configured to:
incorporate, in response to a selection of the selectable indication via the user interface, the next word after the entered words in the at least the portion of a prompt.

14. The system of claim 13, wherein:
the next-word suggestion model comprises a first domain-specific machine-learning model of a plurality of domain-specific machine-learning models;
each domain-specific machine-learning model is based on a domain associated with a specific coding language of a plurality of coding languages; and
wherein the next-word suggestion module is further configured to select, based on the domain associated with the coding language, the first domain-specific machine-learning model from the plurality of domain-specific machine-learning models.

15. The system of claim 14, wherein:
the coordinator is further configured to receive, via the user interface, a storing indication associated with a response selection and, in response to the storing indication, save a hyperparameter set and the complete prompt associated with the response selection to a repository.

16. The system of claim 15, further comprising:
periodically fine tuning each of the plurality of domain-specific machine-learning models based on data stored in the repository.

17. The system of claim 11, wherein:
the coordinator is further configured to:
provide instructions to display, via the user interface, each hyperparameter set associated with each response.

18. The system of claim 11, wherein:
the hyperparameter tuning model is further trained to generate the hyperparameter sets based on an indication of an initial hyperparameter set in an initial iteration of the hyperparameter tuning process; and
wherein the indication of an initial hyperparameter set comprises one of:
a stored hyperparameter set received via the user interface, and
a user-entered hyperparameter set received via the user interface.

19. The system of claim 11, wherein the user interface comprises a software development environment for developing logic code, wherein the software development environment is configured to:
integrate a response selection from a prior iteration of the hyperparameter tuning process into logic code under development in the software development environment.

20. A computing apparatus comprising:
one or more computer readable storage media;
one or more processors operatively coupled with the one or more computer readable storage media; and
a hyperparameter tuning system comprising program instructions stored on the one or more computer readable storage media, wherein the program instructions, when executed by the one or more processors, direct the computing apparatus to at least:
receive, via a user interface, at least a portion of a prompt designed for submission to a generative artificial intelligence model, wherein the prompt instructs the generative artificial intelligence model to return a response in a form of logic code executable by an industrial automation controller;
execute an iteration of a hyperparameter tuning process, comprising:
generate, by a hyperparameter tuning module, a plurality of hyperparameter sets, wherein the hyperparameter tuning module generates the plurality of hyperparameter sets using a hyperparameter tuning model trained to generate hyperparameter sets for iterations of the hyperparameter tuning process based at least in part on hyperparameter sets associated with response selections in prior iterations,
generate, by a prompt generation module, a plurality of complete prompts, wherein each complete prompt comprises one of the plurality of hyperparameter sets and the at least the portion of a prompt,
submit each complete prompt to the generative artificial intelligence model,
receive a plurality of responses from the generative artificial intelligence model, wherein each response of the plurality of responses corresponds to one of the plurality of complete prompts,
provide instructions to display, via the user interface, each response of the plurality of responses, and
receive, via the user interface, a response selection chosen from one of the plurality of responses; and
execute a next iteration of the hyperparameter tuning process based on the response selection.
